(19) United States
(12) Patent Application Publication
(10) Pub. No.: US 2024/0232339 A1
(43) Pub. Date: Jul. 11, 2024

(54) SYSTEM AND METHOD FOR ANOMALY DETECTION IN IOT DATA RECORDS

(71) Applicant: SHIELDIOT LTD., Kfar Saba (IL)

(72) Inventors: Ohad Levin, Haifa (IL); Dan Feldman, Haifa (IL)

(21) Appl. No.: 18/152,493

(22) Filed: Jan. 10, 2023

(51) Int. Cl. G06F 21/55

(52) U.S. Cl. CPC G06F 21/554; G06F 2221/033

(57) ABSTRACT

A method for high accuracy detection of anomalies in a behavior of a plurality of Internet of Things devices communicating over a communication network wherein the anomalies indicative of at least one cyberattack. An appropriate non-transitory computer readable medium and an appropriate computerized system is also described.

### TECHNICAL FIELD

The present disclosure relates to information technology system in general, and to system and method for anomaly detection in IOT data, in particular.

### BACKGROUND OF THE INVENTION

In data analysis, anomaly detection (also referred to as outlier detection and sometimes as novelty detection) is generally understood to be the identification of rare items, events or observations which deviate significantly from the majority of the data and do not conform to a well-defined notion of normal behavior. One of the steps in anomaly detection methods is clustering. The k-means clustering method is a method of vector quantization, originally from signal processing, that aims to partition n observations into k clusters in which each observation belongs to the cluster with the nearest mean (cluster centers or cluster centroid), serving as a prototype of the cluster. The clustering problem is an NP hard problem, thus an optimized method for the clustering is in great need.

The k-means clustering method comprises the following steps: (i) Randomly selecting centroids (center of cluster) for each cluster; (ii) Calculating the distance of all data points to the centroids; (iii) Assigning data points to the closest cluster; (iv) Finding the new centroids of each cluster by taking the mean of all data points in the cluster. Steps (ii), (iii) and (iv) are repeated until all points converge and cluster centers stop moving.

This commonly used method is based on a random selection of centroids in step (i), due to the fact that the clustering problem is an NP hard problem. There is a need in a deterministic method for performing clustering tasks.

### SUMMARY OF THE INVENTION

The present invention is directed towards a system and method designed to identify cyberattacks in high scale IoT networks by utilizing anomaly detection in data records captured from a plurality of remote computerized devices operating IoT technology. Such devices operating IoT technology are denoted herein as IoT devices. The data records obtained from the IoT devices and representing behavior of the IoT devices communicating over a communication network can be captured over an extended period of time. The communication and operation behavior may be represented by data records referring to the operational activities of the IoT devices, and/or to the communication technique and methods thereof. For example, data records referring to the operational activities on the IoT devices may comprise values related to activities such as, start communicating time, stop communicating time, session key used for communication, port utilized for communication, ID of target device communicated with the IoT device, number of TCP/IP packet sent, number of TCP/IP packets received, Upload Content, Length, number of bytes received, number of bytes sent, and the like.

The anomaly detection utilized by the system disclosed in the present invention, may be conducted by a computerized process to identify outliers and then classify the identified outliers to known cyberattacks. The cyberattack classified in the present invention can be any type of offensive maneuver that targets computerized devices such as IoT devices, information systems, infrastructures, computer networks, or personal computer devices. The cyberattacks classified by the system disclosed in the present invention can be malicious actions that involve computerized devices and networks.

In accordance with a preferred embodiment of the present subject matter, a method is provided for high accuracy detection of anomalies in a behavior of a plurality of Internet of Things devices communicating over a communication network, the anomalies indicative of at least one cyberattack, the method comprising:
receiving, by a computerized system, a data set having data records (N records) captured from the plurality of Internet of Things devices in raw data format, a number of clusters (K clusters), a number of outliers (M), and a predefined deterministic error limit (epsilon or ¿);
performing non-heuristic cluster analysis to identify the data records that are members of each of the K clusters;
noting the data record with the largest distance calculated as a potential outlier;
wherein performing non-heuristic cluster analysis for each of the K clusters comprising:
   calculating in an iterative manner the sum of the distances between all the data records to each specific data record;
   generating a matrix of numbers representing the distances between each data record to all other data records, wherein the matrix is of the size N*N;
   noting a minimal sum of distances as a semi-opt point to be a center of the cluster;
   calculating in an iterative manner an OPT′ point having an accuracy of OPT(1+ε) for being the optimal point for a given data set.

In accordance with another preferred embodiment of the present subject matter, calculating in an iterative manner an OPT′ point for each of the K clusters comprises generating a grid having a vertex in a size of semi-opt, divided into (1/ε)\hat{ }2 cells near the OPT′ point; calculating in an iterative manner for all the vertexes in the grid the sum of distances from the vertex to all the data points in the data set; identifying the vertex having the minimal sum of distances as the OPT′ point; calculating in an iterative manner the sum of distances of each of the data records N to that OPT′ point; noting the OPT′ point having the minimal sum of distances as a center of mass for the specific clusters

In accordance with another preferred embodiment of the present subject matter, performing non-heuristic cluster analysis to identify the data records that are members of each of the K clusters is done iteratively for all optional groups of M outlier hidden from the full dataset N.

In accordance with another preferred embodiment of the present subject matter, the method further comprises analyzing each data record from the raw data set, or from the data set after preprocessing procedures; and labeling the outliers according to a type of the cyberattack

In accordance with another preferred embodiment of the present subject matter, the method further comprises determining that a certain outlier is associated with a certain cyberattack when the distance between the certain outlier and a cluster centroid associated with the certain cyberattack is smaller than a certain threshold.

In accordance with another preferred embodiment of the present subject matter, the method further comprises conducting a preprocessing procedure of the data set that comprises removing information of a format that differs from a predefined data format and cleaning noise.

In accordance with another preferred embodiment of the present subject matter, the plurality of internet of things devices operate activities of the multiple internet of things devices.

In accordance with another preferred embodiment of the present subject matter, the plurality of internet of things devices use one or more communication techniques.

In accordance with another preferred embodiment of the present subject matter, the plurality of internet of things devices comprises at least one out of a session key used for communication, a port utilized for communication, an identifier of a target device communicated with one of the multiple internet of things devices, a number of TCP/IP packet sent, and a number of TCP/IP packets received

In accordance with yet another embodiment of the present subject matter, a non-transitory computer readable medium is provided that stores computer executable instructions for:
receiving, by a computerized system, a data set having data records (N records) captured from the plurality of Internet of Things devices in raw data format, a number of clusters (K clusters), a number of outliers (M), and a predefined deterministic error limit (epsilon or ε);
performing non-heuristic cluster analysis to identify the data records that are members of each of the K clusters;
noting the data record with the largest distance calculated as a potential outlier;
wherein performing non-heuristic cluster analysis for each of the K clusters comprising:
calculating in an iterative manner the sum of the distances between all the data records to each specific data record;
generating a matrix of numbers representing the distances between each data record to all other data records, wherein the matrix is of the size N*N;
noting a minimal sum of distances as a semi-opt point to be a center of the cluster;
calculating in an iterative manner an OPT′ point having an accuracy of OPT(1+ε) for being the optimal point for a given data set.

In addition, in accordance with another preferred embodiment of the present subject matter, a computerized system is provided that comprises a processing circuit and memory that are configured to cooperate to:
receive a data set having data records (N records) captured from the plurality of Internet of Things devices in raw data format, a number of clusters (K clusters), a number of outliers (M), and a predefined deterministic error limit (epsilon or ε);
perform non-heuristic cluster analysis to identify the data records that are members of each of the K clusters;
note the data record with the largest distance calculated as a potential outlier;
wherein perform non-heuristic cluster analysis for each of the K clusters comprising:
calculate in an iterative manner the sum of the distances between all the data records to each specific data record;
generate a matrix of numbers representing the distances between each data record to all other data records, wherein the matrix is of the size N*N;
note a minimal sum of distances as a semi-opt point to be a center of the cluster;
calculate in an iterative manner an OPT′ point having an accuracy of OPT(1+ε) for being the optimal point for a given data set.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a computerized process for anomaly detection in IoT data records, in accordance with some exemplary embodiments of the disclosed subject matter;

FIG. 2 shows a flowchart diagram of a method for clustering optimization of N data records into K=1 cluster in accordance with some exemplary embodiments of the disclosed subject matter;

FIG. 3 shows a flowchart diagram of a method for calculating OPT′ point representing the center of a cluster, in accordance with some exemplary embodiments of the disclosed subject matter;

FIG. 4 shows a flowchart diagram of a method for clustering optimization of N data records into K clusters, given M outliers in accordance with some exemplary embodiments of the disclosed subject matter; and

FIGS. 5A-5D show an example of calculating a grid for determining OPT′ point representing the center of a cluster, in accordance with some exemplary embodiments of the disclosed subject matter.

### DETAILED DESCRIPTION OF THE INVENTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

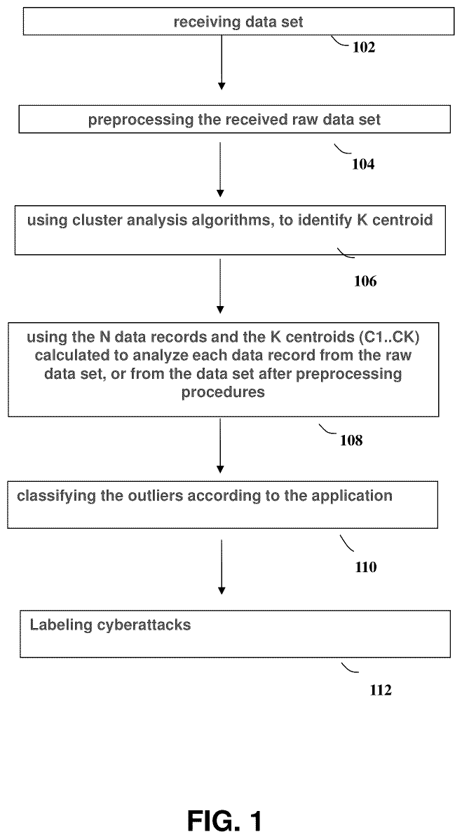

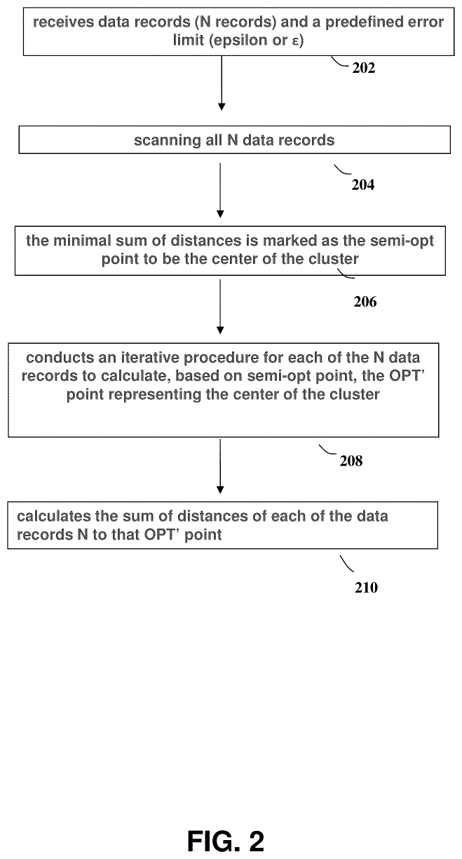

Referring now to FIG. 1 showing a computerized process for anomaly detection in IoT data records, according to exemplary embodiments of the present invention. The anomaly detection in IoT data records system may be a computerized system adapted to perform several steps of the method depicted in FIG. 2. The method is a real time detection of anomalies in a behavior of a plurality of Internet of things devices communicating over a communication network, the anomalies indicative of at least one cyberattack on a scale short execution time. Computerized process 100 for anomaly detection in IoT communication data records comprise the following step:

In step 102, computerized process 100 receives a data set, wherein the data is in a raw data format. Preferably, the data set is received from at least one IoT device, and is IoT web traffic data. In some cases, the computerized system may be connected to a computer-readable medium comprising captured data representing behavior of the IoT devices communicating in a telecommunications network. The communication and operation behavior related data may be captured data referring to the communication and operation behavior of the IoT devices. In some cases, such data may comprise the communication-session key, Service ID, headers of the communication packet, content downloaded or uploaded by the device, number of bytes sent from a device, communication response time, the protocol utilized by the devices for communications, time stamp of initiating the communication, and the like. In some cases, the captured data may be captured by a computerized system designed to communicate with the devices and request the data therefrom. In some other cases the devices may be configured to automatically send the communication and operation behavior related data to a computer connected to a computer-readable medium designed to capture data in a computer readable format. In some cases, such datasets may be structured from large files and tables designed to be utilized by computerized processes. In some other cases the communication and operation behavior can be obtained by tapping the communication traffic at the network operator data center and communicated to the computerized system hereof. Optionally, computerized process 100 conducts a preprocessing-procedure designed to receive and prepare data from IoT devices for anomaly detection.

In step 104, computerized process 100 preprocesses the received raw data set. Computerized system 100 can identify the values in the received data sets which are compatible with a predefined data format. The predefined data format may be such, textual data, time and/or date, numeric data, tables, and the like. For example, the data sets are structured in tables preconfigured to accommodate such values of such data sets. In such an exemplary case, the predefined data format can be a table presenting numeric values with 2 decimal places only. Thus, the computerized system can identify the values in the data sets which are structured as numeric values with 2 decimal places only. Computerized system 100 can remove data records comprising values which are not compatible with the predefined data format. For example, in case a data record comprising textual characters and the predefined data format is structured with numeric values only, the data record comprising the textual characters may be removed by the computerized system. Computerized system 100 can execute a noise cleaning process on the identified data records in the data sets. The noise cleaning process may comprise removing fields and values in the data set which are compatible with the required format but represent noisy data. For example, the noise cleaning process can remove lines with mostly empty values, lines with field values which have no numerical meaning, and the like. Computerized system 100 can aggregate or transform the data set records according to a predefined transformation for optimizing the data in the data sets for any calculations needed. In some cases, the computerized system may remove some of the columns, create new columns, transform category fields to multiple Boolean fields, enrich the data with external data feeds and the like.

In step 106, computerized process 100 uses cluster analysis algorithms, to identify K centroid. Computerized process 100 receives data records (N records), a number of clusters (K clusters), a number of outliers (M) and a predefined error limit (epsilon or ε). The ability of computerized system 100 to calculate and perform cluster analysis algorithms with a predefined error limit is an important ability. The NP-hard algorithms, as well as the heuristics for solving the problem do not consider an error limit as part of the constraints of the clustering process. Computerized process 100 receives as an input the predefined error limit, and accordingly calculates the centroids and assigns each data record to the relevant cluster. Adding a constraint of a predefined error limit allows efficient, deterministic cluster generation. The input for the computerized process is based on known in the art techniques for pre-analyzing the N data records. FIG. 2 further describes cluster analysis algorithm when the number of clusters is 1, i.e., K=1. The general cluster analysis problem is computationally difficult (NP-hard); however, efficient heuristic algorithms converge quickly to a local optimum. The method in the subject matter supersedes heuristic algorithms as it calculates the global optimum (given a predefined error limit), and not just the local optimum for the relevant data set. In the event that K>1, similarly to the method described in FIG. 2, computerized system 100 chooses in every iteration k number of points, and calculates the sum of distances from each of these k points to all other data records in dataset N.

In step 108, computerized system 100 uses the N data records and the K centroids (C1 . . . CK) calculated to analyze each data record from the raw data set, or from the data set after preprocessing procedures. The distance between data record n to each of the K centroids is calculated, and the data record n with the largest distance calculated is noted as a potential outlier. This analysis stage is done in an iterative manner, so that computerized system 100 analyzes each data record in comparison to each of the K centroids representing the K clusters (C1 . . . CK). in each iteration, computerized system 100 arbitrarily removes M data records, as described in details below.

In step 110, computerized system 100 classifies the outliers according to the application. Computerized system 100 can initiate the process denoted as anomalies classification. In some cases, the initiation of the anomalies classification may comprise an initiation of the computerized system on a computerized device. The computerized system 100 receives a data set of identified outliers. In some cases, the outliers may be provided by a data set comprising data records defined as outliers by an outlier detection process. In some cases, such a process may be a computerized process which identifies outliers to be classified, as explained below. The computerized system 100 can receive a data set of cluster centroids labeled with IoT cyberattacks. In such cases the computerized system may receive a data set comprising data records which are associated with specific cyberattacks.

A classification process may occur to a portion of the identified outliers. The classification process may comprise comparison of the data records identified as outliers with the cluster centroids labeled with cyberattacks and thereby identify whether the identified outliers indicate cyberattacks. For example, a certain identified outlier may have a distance which can be essentially equal or approximated to a distance in the cluster centroids, wherein such a distance from the cluster centroids can be labeled with a specific cyberattack, e.g., “A denial of service attack”. In such an exemplary case, the certain identified outlier which was compared with the distance from the cluster centroids may be labeled with a specific cyberattack. In some cases, the distance from a cluster centroid may be associated with a threshold value determining the proximity level required for being classified as a specific IoT cyberattacks. In some cases, such a classification process may be a computerized process conducted by a computerized system. In some cases, the computerized device may be configured with data bases and instructions for conducting such a classification process. In some other cases, such a classification process may be involved by a person or persons operating a computer-based system for identifying classes of anomalies according to predefined cyberattack types. For example, the identified groups of anomalies can be such as DDOS Attack, Device takeover, Device replication, Communication hijacking, Replay attack, Operational anomalies, and the like.

In step 112, computerized system 100 labels cyberattacks. A labeling process occurs for labeling the outlier according to the cyberattack types thereof. For example, a group of outliers may be labeled as a Device takeover attack. In such cases, the labeling of the outlier may be associated with the captured data. Such data can be the device ID, the device protocol, and the like. The computerized system may output to a memory interface, the labeled anomalies associated with the captured data, according to the cyberattack types thereof.

Referring now to FIG. 2 showing a flowchart diagram of a method for clustering optimization of N data records into K=1 cluster in accordance with some exemplary embodiments of the disclosed subject matter. In some exemplary embodiments, computerized process 100 matches N data records to a cluster in which each data record n belongs to the cluster having the minimal sum of distances between each data record n and the cluster or a representation of the cluster (such as a centroid), with a predefined error limit.

In step 202, computerized process 100 receives data records (N records) and a predefined error limit (epsilon or ε). Computerized process 100 utilizes the received attributes and performs an iterative procedure for clustering optimization. The group N of data records comprises at least one data record n. The data records in the received data set can be, for example, a data set of IoT devices communication traffic. The predefined error limit ε constitutes the degree, preferably a percentage, of error the computerized process 100 can have in order for the anomaly detection process to be accurate. In order to be able to meet the predefined error limit in every calculation, the method of the current subject matter is needed. Without using the current subject matter method, just an average error limit may be reached, and not a deterministic error limit.

In step 204, computerized process 100 scans all N data records. For each n data record from group N, computerized process 100 calculates the sum of the distances between all the data records to that specific n data record. This calculation results in a list of N numbers representing the N sums of distances from the specific data record n to all other data records in the data set. The distance between the specific data record n is 0. This step is calculated for each of the N data records, resulting in a matrix of numbers representing the distances from each data record to all other data records, a matrix in the size of N*N.

In step 206, the minimal sum of distances which is the minimal number from the matrix calculated in step 204 is marked as the semi-opt point to be the center of the cluster. The distance from the semi-opt point to the actual optimum point is mathematically assured to be not larger than twice the sum of distances from the semi-opt point due to the triangle inequality rule stating that for any triangle, the sum of the lengths of any two sides must be greater than or equal to the length of the remaining side.

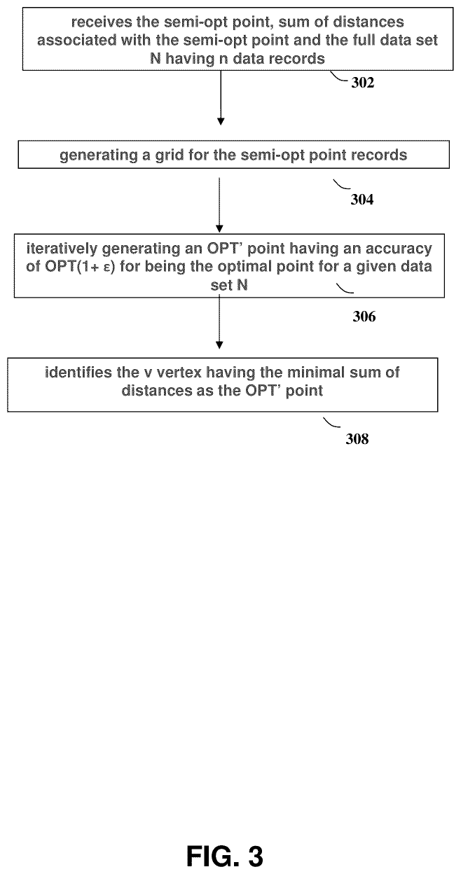

In step 208, computerized process 100 conducts an iterative procedure for each of the N data records to calculate, based on semi-opt point, the OPT′ point representing the center of the cluster, as further described in FIG. 3. In this step a sub procedure is used, calculating an OPT′ point based on a semi-opt point and a n data record from the group of N data record.

In step 210, for each of the calculated OPT′ points, computerized process 100 calculates the sum of distances of each of the data records N to that OPT′ point. The OPT′ point having the minimal sum of distances is chosen to be the center of mass for the data set N having n data records.

Referring now to FIG. 3 showing a flowchart diagram of a method for calculating OPT′ point representing the center of a cluster, in accordance with some exemplary embodiments of the disclosed subject matter.

In step 302, computerized process 100 receives the semi-opt point, sum of distances associated with the semi-opt point and the full data set N having n data records.

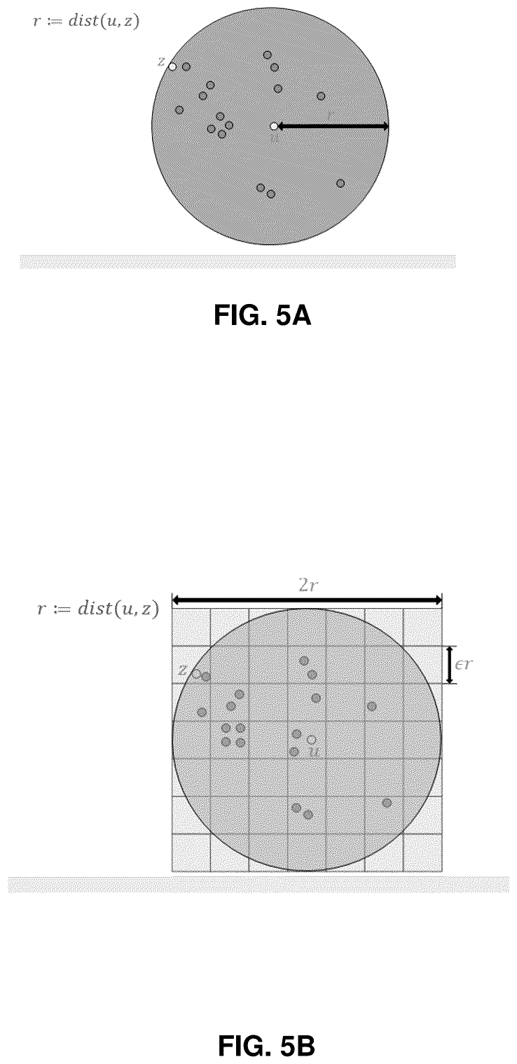

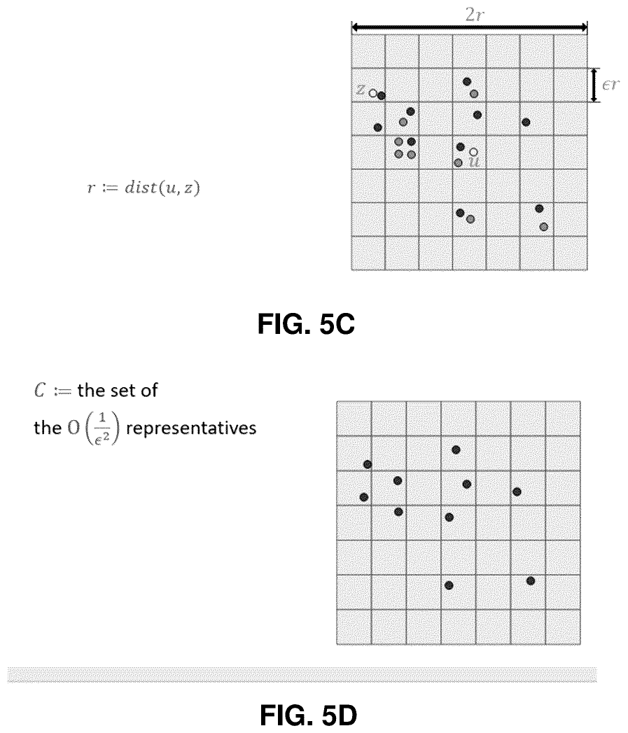

In step 304, for the semi-opt point, computerized process 100 generates a grid (G) or another set of intersecting horizontal and vertical lines defining columns and rows near the semi-opt point. The grid G has an edge in a size of semi-opt, divided into (1/ε)\hat{ }2 cells. Each cell of grid G is, accordingly, in a length of semi-opt*(1/ε). FIG. 5A-5E below further explain grid generation method.

In step 306, computerized process 100 conducts an iterative procedure: for the grid G having V vertexes computerized process 100 generates an OPT′ point having an accuracy of OPT(1+ε) for being the optimal point for a given data set N, in comparison of accuracy of OPT*2 in calculations not using the current subject matter method. For each vertex v from the group V, computerized process 100 calculates the sum of distances from the vertex v to all the data points in the data set N.

In step 308, computerized process 100 identifies the v vertex having the minimal sum of distances as the OPT′ point. This minimal sum of distances, the OPT′ point, is calculated as the VCOST of the vertex v. In an iterative procedure, computerized process 100 chooses the minimal calculated VCOST as the global minimum point.

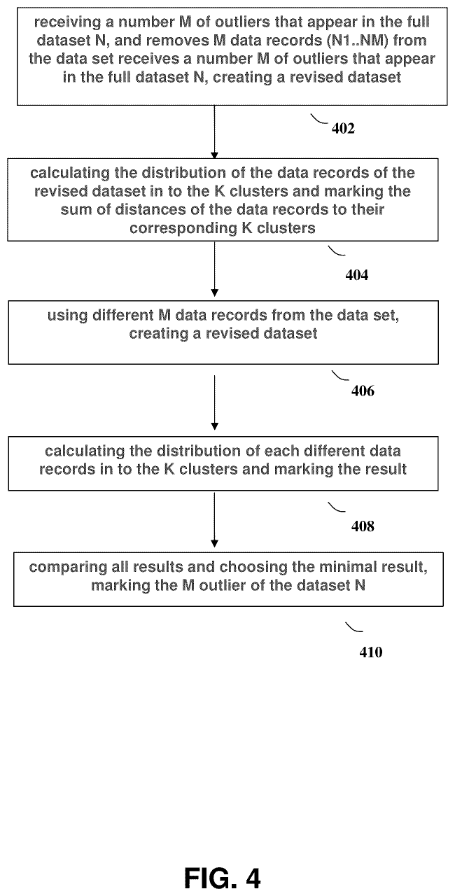

Referring now to FIG. 4 showing a flowchart diagram of a method for clustering optimization of N data records into K clusters, given M outliers in accordance with some exemplary embodiments of the disclosed subject matter. In step 402, computerized process 100 receives a number M of outliers that appear in the full dataset N, and removes M data records (N1 . . . NM) from the data set receives a number M of outliers that appear in the full dataset N, creating a revised dataset N′1. In step 404, computerized process 100 calculates the distribution of the data records of N′1 into the K clusters and marks the sum of distances of the N′1 data records to their corresponding K clusters as RESULTN′1. In step 406, computerized process 100 uses different M data records from the data set, creating a revised dataset N′2. In step 408, computerized process 100 calculates the distribution of the data records of N′2 into the K clusters and marks the result as RESULTN′2. This process is done iteratively for all optional groups of M outlier hidden from the full dataset N. In step 410, computerized process 100 compares all RESULTN′1 . . . RESULTN′N, chooses the minimal RESULTN′X and the RESULTN′X and the M outliers are marked as the M outlier of the dataset N.

In step 404, computerized process 100 calculates the distribution of the N data records into the K clusters (C1 . . . CK) by iteratively conducting the procedure described in FIG. 2 and FIG. 3 above. Computerized process 100 iteratively chooses

$$( \begin{matrix}n \\ k\end{matrix} )$$

from the input received. N is larger than K and therefore computerized process 100 calculates all the options of choosing the number of k-element subsets of an n-element set, and for each option outputs the result which is the sum of distances between all the data records that are part of a specific cluster to the center of mass of the cluster. for each such distribution done according to the procedures in FIGS. 2 and 3.

Referring now to FIGS. 5A-5D showing an example of calculating a grid for determining OPT′ point representing the center of a cluster, in accordance with some exemplary embodiments of the disclosed subject matter. On a specific set of data records, computerized process 10 generates grid 400 having an edge in a size of semi-opt, divided into (1/ε)\hat{ }2 cells. Each cell of grid G is, accordingly, in a length of semi-opt*(1/ε). In step 502 shown in FIG. 5A, an arbitrary point U is chosen. This point is considered the optimum point on a non-calculative basis, as a start point for generating the grid. In addition, the farthest point from point U is chosen, marked as point Z. The distance between the point U and the point Z is calculated to be R. A circle having a center at point U and a radius of R is built. In step 510 shown in FIG. 5B, the circle is divided into a grid, each cell of the grid is in a length of semi-opt*(1/ε). In step 512 shown in FIG. 5C, a representative point is picked from every non-empty cell according to the calculation described in FIG. 3 above. In step 514 shown in FIG. 5D all the representative data records are marked, and the set is of

$$O ( \frac{1}{{ϵ}^{2}} )$$

representatives.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiment was chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, python, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

1. A method for high accuracy detection of anomalies in a behavior of a plurality of Internet of Things devices communicating over a communication network, the anomalies indicative of at least one cyberattack, the method comprising:
receiving, by a computerized system, a data set having data records (N records) captured from the plurality of Internet of Things devices in raw data format, a number of clusters (K clusters), a number of outliers (M), and a predefined deterministic error limit (epsilon or ε);
performing non-heuristic cluster analysis to identify the data records that are members of each of the K clusters; and
noting the data record with the largest distance calculated as a potential outlier,
wherein performing non-heuristic cluster analysis for each of the K clusters comprises:
calculating in an iterative manner the sum of the distances between all the data records to each specific data record;
generating a matrix of numbers representing the distances between each data record to all other data records, wherein the matrix is of the size N*N;
noting a minimal sum of distances as a semi-opt point to be a center of the cluster; and
calculating in an iterative manner an OPT′ point having an accuracy of OPT(1+ε) for being the optimal point for a given data set.

2. The method according to claim 1, wherein calculating in an iterative manner an OPT′ point for each of the K clusters comprising:
generating a grid having a vertex in a size of semi-opt, divided into (1/ε)\hat{ }2 cells near the OPT′ point;
calculating in an iterative manner for all the vertexes in the grid the sum of distances from the vertex to all the data points in the data set;
identifying the vertex having the minimal sum of distances as the OPT′ point;
calculating in an iterative manner the sum of distances of each of the data records N to that OPT′ point; and
noting the OPT′ point having the minimal sum of distances as a center of mass for the specific clusters.

3. The method according to claim 1, wherein performing non-heuristic cluster analysis to identify the data records that are members of each of the K clusters is done iteratively for all optional groups of M outlier hidden from the full dataset N.

4. The method according to claim 1, further comprising:
analyzing each data record from the raw data set, or from the data set after preprocessing procedures; and
labeling the outliers according to a type of the cyberattack

5. The method according to claim 1, further comprising determining that a certain outlier is associated with a certain cyberattack when the distance between the certain outlier and a cluster centroid associated with the certain cyberattack is smaller than a certain threshold.

6. The method according to claim 1, further comprising conducting a preprocessing procedure of the data set that comprises removing information of a format that differs from a predefined data format and cleaning noise.

7. The method according to claim 1, wherein the plurality of internet of things devices operate activities of the multiple internet of things devices.

8. The method according to claim 1, wherein the plurality of internet of things devices use one or more communication techniques.

9. The method according to claim 1, wherein the plurality of internet of things devices comprise at least one out of a session key used for communication, a port utilized for communication, an identifier of a target device communicated with one of the multiple internet of things devices, a number of TCP/IP packet sent, and a number of TCP/IP packets received

10. A non-transitory computer readable medium that stores computer executable instructions for:
receiving, by a computerized system, a data set having data records (N records) captured from the plurality of Internet of Things devices in raw data format, a number of clusters (K clusters), a number of outliers (M), and a predefined deterministic error limit (epsilon or ε);
performing non-heuristic cluster analysis to identify the data records that are members of each of the K clusters; and
noting the data record with the largest distance calculated as a potential outlier,
wherein performing non-heuristic cluster analysis for each of the K clusters comprises:
calculating in an iterative manner the sum of the distances between all the data records to each specific data record;
generating a matrix of numbers representing the distances between each data record to all other data records, wherein the matrix is of the size N*N;
noting a minimal sum of distances as a semi-opt point to be a center of the cluster; and
calculating in an iterative manner an OPT′ point having an accuracy of OPT(1+ε) for being the optimal point for a given data set.

11. A computerized system that comprises a processing circuit and memory that are configured to cooperate to:
receive a data set having data records (N records) captured from the plurality of Internet of Things devices in raw data format, a number of clusters (K clusters), a number of outliers (M), and a predefined deterministic error limit (epsilon or ε);
perform non-heuristic cluster analysis to identify the data records that are members of each of the K clusters; and
note the data record with the largest distance calculated as a potential outlier,
wherein perform non-heuristic cluster analysis for each of the K clusters comprising:
calculate in an iterative manner the sum of the distances between all the data records to each specific data record;
generate a matrix of numbers representing the distances between each data record to all other data records, wherein the matrix is of the size N*N;
note a minimal sum of distances as a semi-opt point to be a center of the cluster;
calculate in an iterative manner an OPT′ point having an accuracy of OPT(1+ε) for being the optimal point for a given data set.
